(19) United States
(12) Patent Application Publication
(10) Pub. No.: US 2025/0106787 A1
(43) Pub. Date: Mar. 27, 2025

(54) UPLINK POWER CONTROL FOR MULTIPLE RANDOM ACCESS CHANNEL PROCEDURES

(71) Applicant: QUALCOMM Incorporated, San Diego, CA (US)

(72) Inventors: Shaozhen GUO, Beijing (CN); Mostafa KHOSHNEVISAN, San Diego, CA (US); Jing SUN, San Diego, CA (US); Xiaoxia ZHANG, San Diego, CA (US); Fang YUAN, Beijing (CN); Yan ZHOU, San Diego, CA (US); Tao LUO, San Diego, CA (US); Peter GAAL, San Diego, CA (US)

(21) Appl. No.: 18/729,009

(22) PCT Filed: Mar. 31, 2022
(86) PCT No.: PCT/CN2022/084448

§ 371 Date: Jul. 15, 2024

(51) Int. Cl. H04W 52/36; H04W 74/0833

(52) U.S. Cl. CPC H04W 52/367; H04W 74/0833

(57) ABSTRACT

Methods, systems, and devices for wireless communication at a user equipment (UE) are described. The UE may be configured to support uplink power control for multiple random access channel (RACH) procedures. A medium access control layer entity at the UE may maintain multiple sets of counters and parameters for multiple simultaneous RACH procedures. In some cases, the UE may perform simultaneous RACH procedures with network entities associated with different timing advance groups, and the UE may associate the counters and parameters of the RACH procedure with the timing advance group. In other cases, the UE may associate the counters and parameters of the RACH procedure with multiple control resource set pool indexes which may correspond to multiple transmission reception points. Each set of counters may be associated with an uplink power control that the UE may use to determine the PRACH transmission power for each RACH procedure.

### CROSS REFERENCE

The present Application is a 371 national phase filing of International PCT Application No. PCT/CN2022/084448 by GUO et al., entitled “UPLINK POWER CONTROL FOR MULTIPLE RANDOM ACCESS CHANNEL PROCEDURES,” filed Mar. 31, 2022, which is assigned to the assignee hereof, and which is expressly incorporated by reference in its entirety herein.

### FIELD OF TECHNOLOGY

The following relates to wireless communication at a user equipment (UE), including uplink power control for multiple random access channel (RACH) procedures.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more base stations, each supporting wireless communication for communication devices, which may be known as user equipment (UE). In some wireless communication systems, a UE may communicate with a network entity according to a random access procedure. Techniques for communication between UEs and network entities may be improved.

### SUMMARY

The described techniques relate to improved methods, systems, devices, and apparatuses that support uplink power control for multiple random access channel (RACH) procedures. For example, the described techniques provide for a higher layer entity (e.g., medium access control (MAC) entity) at a user equipment (UE) to maintain multiple sets of counters. In particular, the UE may maintain separate counters and parameters (e.g., separate preamble transmission counters and power ramp counters) for multiple simultaneous RACH procedures. In particular, a UE may communicate with multiple transmission reception points (TRPs) simultaneously. In other cases, the UE may perform simultaneous RACH procedures with network entities associated with different timing advance groups. The UE may maintain separate counters associated with multiple control resource set pool indexes which may correspond to multiple TRPs. Additionally or alternatively, the MAC entity at the UE may determine multiple sets of counters associated with multiple timing advance groups. Each set of counters may be associated with an uplink power control that the UE may use to determine the PRACH transmission power for each RACH procedure.

When a RACH procedure is initiated by a network entity, the physical (PHY) layer in the UE may indicate to a MAC entity at the UE that a set of counters is to be initiated for the RACH procedure. Accordingly, the MAC entity may initiate and subsequently update the counters (e.g., incrementing, resetting, or suspending the counters) for each RACH occasion based on the status of the RACH procedure. For each RACH occasion, the PHY layer may notify the MAC layer to suspend or increment the value of each counter. The MAC entity may set the preamble received target power based on the value of each counter. The MAC entity may transmit an indication of the counter values, the preamble received target power, or both to the PHY layer at the UE, which may be used to determine the transmission power for each RACH occasion. In this way, the UE may determine a transmission power for each RACH transmission.

A method for wireless communication at a user equipment (UE) is described. The method may include receiving a first downlink control channel order triggering a first random access procedure and a second downlink control channel order triggering a second random access procedure that temporally overlaps with the first random access procedure, initiating a first set of counters associated with uplink power control for the first random access procedure and a second set of counters associated with uplink power control for the second random access procedure, transmitting a first uplink random access channel message in accordance with the first downlink control channel order and a second uplink random access channel message in accordance with the second downlink control channel order, and updating values of the first set of counters based on a first status of the first random access procedure and values of the second set of counters based on a second status of the second random access procedure.

An apparatus for wireless communication at a UE is described. The apparatus may include a processor, memory coupled with the processor, and instructions stored in the memory. The instructions may be executable by the processor to cause the apparatus to receive a first downlink control channel order triggering a first random access procedure and a second downlink control channel order triggering a second random access procedure that temporally overlaps with the first random access procedure, initiate a first set of counters associated with uplink power control for the first random access procedure and a second set of counters associated with uplink power control for the second random access procedure, transmit a first uplink random access channel message in accordance with the first downlink control channel order and a second uplink random access channel message in accordance with the second downlink control channel order, and update values of the first set of counters based on a first status of the first random access procedure and values of the second set of counters based on a second status of the second random access procedure.

Another apparatus for wireless communication at a UE is described. The apparatus may include means for receiving a first downlink control channel order triggering a first random access procedure and a second downlink control channel order triggering a second random access procedure that temporally overlaps with the first random access procedure, means for initiating a first set of counters associated with uplink power control for the first random access procedure and a second set of counters associated with uplink power control for the second random access procedure, means for transmitting a first uplink random access channel message in accordance with the first downlink control channel order and a second uplink random access channel message in accordance with the second downlink control channel order, and means for updating values of the first set of counters based on a first status of the first random access procedure and values of the second set of counters based on a second status of the second random access procedure.

A non-transitory computer-readable medium storing code for wireless communication at a UE is described. The code may include instructions executable by a processor to receive a first downlink control channel order triggering a first random access procedure and a second downlink control channel order triggering a second random access procedure that temporally overlaps with the first random access procedure, initiate a first set of counters associated with uplink power control for the first random access procedure and a second set of counters associated with uplink power control for the second random access procedure, transmit a first uplink random access channel message in accordance with the first downlink control channel order and a second uplink random access channel message in accordance with the second downlink control channel order, and update values of the first set of counters based on a first status of the first random access procedure and values of the second set of counters based on a second status of the second random access procedure.

In some examples of the method, apparatuses, and non-transitory computer-readable medium described herein, receiving the first downlink control channel order and the second downlink control channel order may include operations, features, means, or instructions for receiving the first downlink control channel order associated with a first control resource set pool index value and receiving the second downlink control channel order associated with a second control resource set pool index value different from the first control resource set pool index value.

In some examples of the method, apparatuses, and non-transitory computer-readable medium described herein, receiving the first downlink control channel order and the second downlink control channel order may include operations, features, means, or instructions for receiving the first downlink control channel order associated with a first timing advance group and receiving the second downlink control channel order associated with a second timing advance group different from the first timing advance group.

Some examples of the method, apparatuses, and non-transitory computer-readable medium described herein may further include operations, features, means, or instructions for sending, from a physical layer at the UE to a medium access control layer at the UE, an indication of the first random access procedure and the second random access procedure, setting, at the medium access control layer at the UE, a first random access target reception power for the first random access procedure based on the first set of counters and a second random access target reception power for the second random access procedure based on the second set of counters, and instructing, the physical layer at the UE, to transmit a first random access preamble based on the first random access target reception power and a second random access preamble based on the second random access target reception power.

In some examples of the method, apparatuses, and non-transitory computer-readable medium described herein, the first set of counters includes a first preamble transmission counter associated with the first random access procedure and a first preamble power ramping counter associated with the first random access procedure, and the second set of counters includes a second preamble transmission counter associated with the second random access procedure and a second preamble power ramping counter associated with the second random access procedure.

Some examples of the method, apparatuses, and non-transitory computer-readable medium described herein may further include operations, features, means, or instructions for receiving an indication of a first threshold value associated with a first preamble transmission counter in the first set of counters and a second threshold value associated with a second preamble transmission counter in the second set of counters, where the first set of counters and the second set of counters may be updated based on the first threshold value and the second threshold value.

Some examples of the method, apparatuses, and non-transitory computer-readable medium described herein may further include operations, features, means, or instructions for resetting the values of the first set of counters based on the first random access procedure being successful and incrementing the values of the second set of counters based on the second random access procedure being unsuccessful.

Some examples of the method, apparatuses, and non-transitory computer-readable medium described herein may further include operations, features, means, or instructions for receiving a first downlink control message of the first random access procedure in response to the first uplink random access channel message, receiving a first downlink control message of the second random access procedure in response to the second uplink random access channel message, initiating a first response window in response to receiving the first downlink control message of the first random access procedure, and initiating a second response window in response to receiving the first downlink control message of the second random access procedure, where the first response window and the second response window may be independent of each other.

Some examples of the method, apparatuses, and non-transitory computer-readable medium described herein may further include operations, features, means, or instructions for receiving a second downlink message of the first random access procedure within the first response window and incrementing the value of a preamble transmission counter in the second set of counters based on an expiration of the second response window prior to reception of a second downlink message of the second random access procedure.

Some examples of the method, apparatuses, and non-transitory computer-readable medium described herein may further include operations, features, means, or instructions for incrementing the value of a preamble power ramping counter in the second set of counters may be based on signaling from a physical layer at the UE to a medium access control layer at the UE.

Some examples of the method, apparatuses, and non-transitory computer-readable medium described herein may further include operations, features, means, or instructions for receiving a third downlink control channel order triggering a second attempt of the second random access procedure based on a first attempt of the second random access procedure being unsuccessful and transmitting a third uplink random access channel message in accordance with the third downlink control channel order triggering the second random access procedure.

Some examples of the method, apparatuses, and non-transitory computer-readable medium described herein may further include operations, features, means, or instructions for determining, at a physical layer at the UE, that a beam associated with the third uplink random access channel message may be the same as a beam associated with the second uplink random access channel message, notifying, a medium access control layer at the UE, to increment the value of a preamble power ramping counter in the second set of counters based on the determination, and incrementing, at the medium access control layer at the UE, the value of the preamble power ramping counter in the second set of counters based on the notifying.

Some examples of the method, apparatuses, and non-transitory computer-readable medium described herein may further include operations, features, means, or instructions for determining, at a physical layer at the UE, that a beam associated with the third uplink random access channel message may be different from a beam associated with the second uplink random access channel message, notifying, a medium access control layer at the UE, to suspend the value of a preamble power ramping counter in the second set of counters based on the determination, and suspending, at the medium access control layer at the UE, the value of the preamble power ramping counter in the second set of counters based on the notifying.

In some examples of the method, apparatuses, and non-transitory computer-readable medium described herein, the first downlink control channel order may be associated with a first transmission reception point and the second downlink control channel order may be associated with a second transmission reception point.

In some examples of the method, apparatuses, and non-transitory computer-readable medium described herein, the first downlink control channel order may be associated with a first component carrier associated with at least a first timing advance group and the second downlink control channel order may be associated with a second component carrier associated with at least a second timing advance group different from the first timing advance group.

### BRIEF DESCRIPTION OF THE DRAWINGS

FIG. 1 illustrates an example of a wireless communications system that supports uplink power control for multiple random access channel (RACH) procedures in accordance with one or more aspects of the present disclosure.

FIG. 2 illustrates an example of a wireless communications system that supports uplink power control for multiple RACH procedures in accordance with one or more aspects of the present disclosure.

FIG. 3 illustrates an example of a process flow that supports uplink power control for multiple RACH procedures in accordance with one or more aspects of the present disclosure.

FIG. 4 illustrates an example of a process flow that supports uplink power control for multiple RACH procedures in accordance with one or more aspects of the present disclosure.

FIGS. 5 and 6 show block diagrams of devices that support uplink power control for multiple RACH procedures in accordance with one or more aspects of the present disclosure.

FIG. 7 shows a block diagram of a communications manager that supports uplink power control for multiple RACH procedures in accordance with one or more aspects of the present disclosure.

FIG. 8 shows a diagram of a system including a device that supports uplink power control for multiple RACH procedures in accordance with one or more aspects of the present disclosure.

FIGS. 9 and 10 show flowcharts illustrating methods that support uplink power control for multiple RACH procedures in accordance with one or more aspects of the present disclosure.

### DETAILED DESCRIPTION

In some wireless communication systems, a user equipment (UE) and a transmission reception point (TRP) (e.g., base station) may communicate using a contention-free random access channel (RACH) procedure. As part of the RACH procedure, the UE may determine a transmission power for a physical random access channel (PRACH). In particular, the UE may determine a transmission power for uplink messages in the RACH procedure using a preamble transmission counter and a power ramp counter. A higher layer entity (e.g., medium access control (MAC) entity) at the UE may maintain a set of counters associated with an uplink power control. For example, the MAC entity may initialize a preamble transmission counter associated with a number of transmissions of the RACH procedure and a power ramp counter associated with a power value of the RACH procedure. The MAC entity may update the counters based on the status of the RACH procedure. For example, the MAC entity may increment the preamble transmission counter on each uplink transmission of the RACH procedure. In addition, the MAC entity may reset the preamble transmission counter either when the RACH procedure is successfully completed or when the preamble transmission counter reaches a maximum value. Additionally or alternatively, the MAC entity may also increment the power ramp counter if the beam configuration used by the UE and base station is the same between RACH occasions. For example, if the PHY layer uses the same beam configuration for consecutive transmissions (e.g., does not change the beam configuration for retransmission), the MAC entity may increment the power ramp counter by 1. If the PHY layer switches beam configurations between consecutive RACH occasions, the MAC entity may suspend (e.g., not update) the power ramp counter. In some cases, the UE may simultaneously communicate with multiple transmission reception points using different RACH procedure.

In accordance with techniques, methods, devices, and apparatuses described herein, a UE may use multiple PRACH transmission powers for different RACH procedures. For example, a higher layer entity (e.g., MAC entity) at the UE may maintain multiple sets of counters. In particular, the UE may maintain separate counters and parameters (e.g., separate preamble transmission counters and power ramp counters) for multiple simultaneous RACH procedures. In some cases, the UE may simultaneously communicate with multiple TRPs within the same serving cell. For example, the UE may receive multiple physical downlink control channel (PDCCH) orders corresponding to multiple TRPs, each associated with a different control resource set pool index. In other cases, the UE may perform simultaneous RACH procedures with network entities associated with different timing advance groups. The UE may maintain separate counters associated with multiple control resource set pool indexes which may correspond to multiple TRPs. In some examples, the UE may associate a preamble transmission counter and a power ramping counter with each control resource set pool index. Additionally or alternatively, the MAC entity at the UE may determine multiple sets of counters associated with multiple timing advance groups. Each set of counters may be associated with an uplink power control that the UE may use to determine the PRACH transmission power for each RACH procedure. When a RACH procedure is initiated by a network entity, the PHY layer in the UE may indicate to a MAC entity at the UE that a set of counters is to be initiated for the RACH procedure. Accordingly, the MAC entity may initiate and subsequently update the counters (e.g., incrementing, resetting, or suspending the counters) for each RACH occasion based on the status of the RACH procedure. For each RACH occasion, the PHY layer may notify the MAC layer to suspend or increment the value of the counters. For example, the PHY layer may notify the MAC layer to suspend the power ramp counter of the RACH procedure if the UE changes the spatial domain transmission filter or the beam between a consecutive RACH transmission (e.g., between transmission and retransmission or between two retransmissions). In another example, the PHY layer may notify the MAC layer to increment the power ramp counter of the RACH procedure if the UE does not change the spatial domain transmission filter or beam between a consecutive RACH transmission (e.g., between transmission and retransmission or between two retransmissions). The MAC entity may suspend or increment the power ramp counter based on the PHY layer notification and set the preamble received target power based on the value of the counters. The MAC layer may transmit the preamble received target power to the PHY layer at the UE which may be used to determine the transmission power for each RACH occasion. The MAC entity at the UE may increment the preamble transmission counter on each RACH occasion of the RACH procedure. In some cases, a network entity may configure the UE with a threshold value for a preamble transmission counter. If the preamble transmission counter reaches the threshold, the MAC entity may reset the corresponding counter. As such, the PHY layer in conjunction with the MAC entity may determine a transmission power for each RACH occasion of the multiple RACH procedures.

Particular aspects of the subject matter described here may be implemented to realize one or more potential advantages. The described techniques may provide for efficient uplink synchronization between multiple TRPs. As such, the UE may engage in simultaneous communication between multiple TRPs having different control resource set resource pool indexes or belonging to different timing advance groups. This may lead to reduced latency between the devices.

Aspects of the disclosure are initially described in the context of wireless communications systems. An additional wireless communication system and process flows are then provided to describe aspects of the disclosure. Aspects of the disclosure are further illustrated by and described with reference to apparatus diagrams, system diagrams, and flowcharts that relate to uplink power control for multiple RACH procedures.

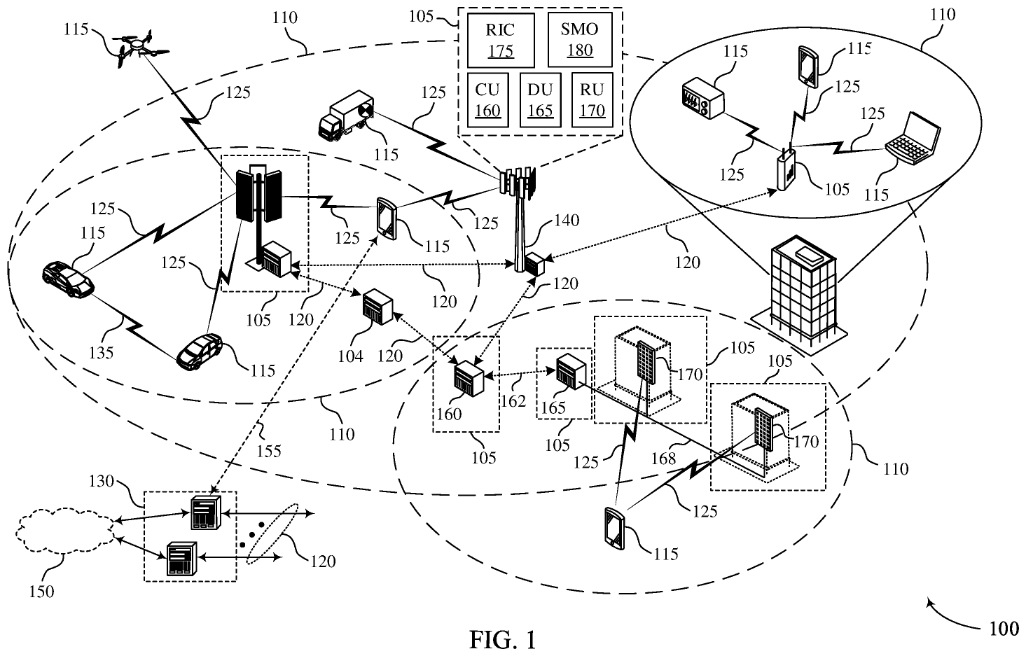

FIG. 1 illustrates an example of a wireless communications system 100 that supports uplink power control for multiple RACH procedures in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a TRP. One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, MAC layer) functionality and signaling, and may each be at least partially controlled by the CU 160. Additionally or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support uplink power control for multiple RACH procedures as described herein. For example, some operations described as being performed by a UE 115 or a network entity 105 (e.g., a base station 140) may additionally or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers (CCs) and one or more uplink CCs according to a carrier aggregation configuration. Carrier aggregation may be used with both frequency division duplexing (FDD) and time division duplexing (TDD) CCs. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with CCs operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

In some wireless communication systems (e.g., wireless communications system 100), a UE 115 and a TRP (e.g., base station 105) may communicate using a contention-free RACH procedure. A TRP or a network entity may initiate a random access procedure by a physical downlink control channel (PDCCH) order, or by an RRC message. When a RACH procedure is performed on a serving cell, a TRP may initiate the procedure by a PDCCH order. Upon initiation, a MAC entity of the UE 115 may perform one or more initialization functions (such as flushing the Msg3 and MsgA buffers, setting the preamble transmission counter and preamble power ramping count to 1, setting the preamble backoff to 0 milliseconds (ms), and setting the power offset for 2 step random access to 0 decibels (dB)).

In some cases, a physical (PHY) layer at the UE may determine a transmission power for a physical random access channel (PRACH) on an active uplink bandwidth part f of a serving cell c based on a downlink reference signal for a serving cell c in a transmission occasion i. The transmission power may be calculated as Equation 1:

$${P}_{PRACH , b , f , c} ( i ) = min \{ {P}_{CMAX , f , c} ( i ) , {P}_{PRACH , target , f , c} + {PL}_{b , f , c} \} \qquad Equation ( 1 )$$

where P_{CMAX,f,c} is the configured maximum power output for one serving cell, P_{PRACH,target,f,c} is the PRACH target reception power controlled by higher layers (e.g., MAC entity), and PL_{b,f,c} is the pathloss for the active uplink bandwidth part of the carrier based on the downlink reference signal (e.g., measured per synchronized signal block of the RACH) associated with the PRACH transmission. In some cases, the UE 115 may determine the pathloss by measuring a synchronization signal block because the pathloss may not change as each RACH occasion may be associated with an synchronization signal block.

The UE 115 may determine a PRACH target reception power based on an initial preamble received target power, delta preamble, preamble power ramping counter, preamble power ramping step, and power offset for 2 step RACH. A serving cell may configure the initial preamble received target power through higher level signaling (e.g., RRC). The initial preamble received target power may refer to the initial random access preamble power for a 4 step RACH procedure. The delta preamble may refer to a power offset that may be determined from the RACH preamble format included in the PDCCH order. In some cases, the UE 115 may receive a configuration associated with a mapping of RACH preamble formats to delta preamble values, where the mapping may be predetermined in the specification. For example, for long preamble formats, the preamble formats 0, 1, 2, and 3 may map to delta preamble values 0 decibels (dB), −3 dB, −6 dB, and 0 dB respectively. Additionally or alternatively, short preamble formats may be mapped to delta preamble values that are dependent on a message 1 or message A sub-carrier spacing.

In some examples, the MAC entity at the UE may configure a preamble transmission counter that may be initialized to 1 when the PHY layer at the UE indicates the start of a RACH procedure. Accordingly, the MAC entity may increment the preamble transmission counter on each RACH occasion. The MAC entity may also configure the preamble power ramping counter such that if the preamble transmission counter is greater than 1, and the UE 115 has not received a notification to suspend the power ramping counter from the lower layers, and the listen-before-talk (LBT) indication from the lower layers for the last RACH transmission. Additionally, the UE 115 may not change the synchronized signal block or the channel state information (CSI) reference signal (RS) from the last RACH transmission. In such cases, the MAC entity may increment the preamble power ramping counter by 1.

The MAC entity may configure the preamble power ramping counter from the power RampingStep variable which may be set for a 4 step RACH procedure. The MAC entity may set the power offset for 2 step RACH such that if the UE switches from a 2 step RACH procedure to 4 step RACH procedure the power offset is determined as:

(preamble_power_ramping_counter−1)*(MsgA_preamble_power_ramping_step-preamble_power_ramping_step)

Otherwise, the UE 115 may determine the power offset to be 0.

For each RACH occasion, the MAC entity may set the preamble received target power and compute the random access (RA) radio network temporary identifier (RNTI) associated with the PRACH occasion. In some cases, the MAC entity may also instruct the PHY layer to transmit a RACH preamble to the base station using the selected PRACH occasion corresponding to the RA-RNTI, if available, the preamble index, and the preamble received target power. The PHY layer may use the preamble received target power to determine the transmission power for the PRACH.

In some cases, it may be beneficial for the UE to perform multiple RACH procedures simultaneously (e.g., for fast uplink synchronization). However, in some wireless communication systems, if a new RACH procedure is triggered, then the UE may either continue with the ongoing procedure or terminate the current procedure and start a new procedure. Thus, some wireless communication systems may not provide for performing multiple RACH procedures which may include the UE maintaining multiple PRACH transmission powers for the different RACH procedures.

In accordance with the techniques, methods, and apparatuses described herein, a UE 115 may use different PRACH transmission powers for different RACH procedures. For example, the MAC entity at the UE 115 may maintain multiple sets of counters. In particular, the UE 115 may maintain separate counters and parameters (e.g., separate preamble transmission counters and power ramp counters) for multiple simultaneous RACH procedures that temporally overlap with each other. In particular, a UE 115 may communicate with multiple TRPs simultaneously. In other cases, the UE 115 may perform simultaneous RACH procedures with network entities 105 associated with different timing advance groups. The UE 115 may maintain separate counters associated with multiple control resource set pool indexes which may correspond to multiple TRPs. Additionally or alternatively, the MAC entity at the UE 115 may determine multiple sets of counters associated with multiple timing advance groups. Each set of counters may be associated with an uplink power control that the UE 115 may use to determine the PRACH transmission power for each RACH procedure. When a RACH procedure is initiated by a network entity, the UE 115 may initiate a set of counters for the RACH procedure. In particular, the MAC entity at the UE 115 may initiate and subsequently update the counters (e.g., incrementing, resetting, or suspending the counters) for each RACH occasion based on a status of the RACH procedure. For each RACH occasion, the PHY layer at the UE 115 may notify the MAC layer at the UE 115 to suspend or increment the value of the counters. For example, the PHY layer at the UE 115 may notify the MAC layer at the UE 115 to suspend the power ramp counter of the RACH procedure if the UE 115 changes the spatial domain transmission filter or the beam between a consecutive RACH transmission (e.g., between transmission and retransmission or between two retransmissions). In another example, the PHY layer at the UE 115 may notify the MAC layer at the UE 115 to increment the power ramp counter of the RACH procedure if the UE 115 does not change the spatial domain transmission filter or beam between a consecutive RACH transmission (e.g., between transmission and retransmission or between two retransmissions). The MAC entity at the UE 115 may suspend or increment the power ramp counter based on the PHY layer notification and set the preamble received target power based on the value of the counters. The MAC entity at the UE 115 may indicate the preamble received target power to the PHY layer at UE 115. The MAC entity may transmit an indication of the preamble received target power which may be used by the PHY layer to determine the transmission power for each RACH occasion.

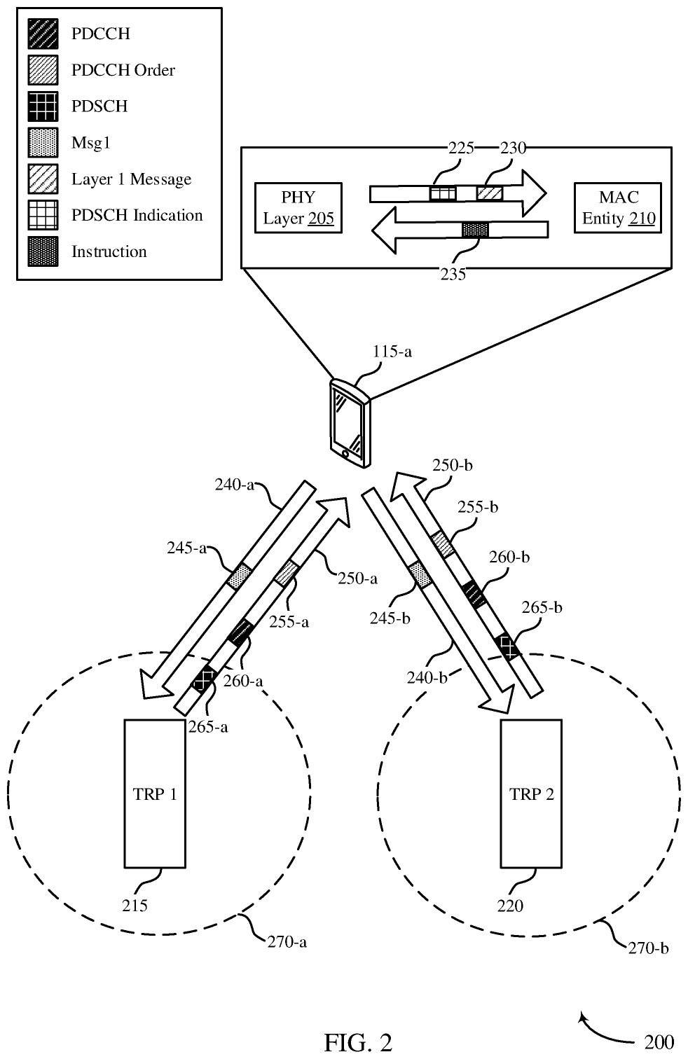

FIG. 2 illustrates an example of a wireless communication system 200 that supports uplink power control for multiple RACH procedures in accordance with one or more aspects of the present disclosure. UE 115-a may communicate with multiple transmission and reception points (TRPs) simultaneously. In some implementations, TRP 1 and a TRP 2 may be examples of TRPs associated with different control resource set pool index values. In other implementations, TRP 1 and TRP 2 may be examples of TRPs of different timing advance groups 270 (e.g., 270-a and 270-b). For example, timing advance group 270-a may include one or more TRPs 215 which may communicate with the UE 115-a using a RACH procedure, and timing advance group 270-b may include one or more TRPs 220 which may communicate with the UE 115-a using a separate RACH procedure. As described herein, the UE 115-a may simultaneously communicate with TRP 1 and TRP 2 of differing control resource pool indexes or timing advance groups over multiple RACH procedures.

The UE 115-a may communicate with TRP 1 over an uplink channel 240-a and a downlink channel 250-a and TRP 2 over an uplink channel 240-b and a downlink channel 250-b. In some cases, the UE 115-a may receive a PDCCH order 255-a which initiates a RACH procedure with TRP 1 and a PDCCH order 255-b which initiates a second temporally overlapping RACH procedure with TRP 2. The PHY layer 205 at the UE 115-a may send a layer 1 message 230 associated with each RACH procedure to the MAC entity 210 which may indicate an initiation of a RACH procedure corresponding to the TRP. In response to each received layer 1 message, the MAC entity 210 at the UE 115-a may initialize a set of counters and one or more parameters associated with uplink power control for the RACH procedure. The set of counters may include a preamble transmission counter and a power ramp counter. Upon initiation of a RACH procedure, the UE 115-a may transmit a Msg1 245-a (e.g., first message) to TRP 1 over uplink channel 240-a in accordance with the first PDCCH order 255-a and a separate Msg1 245-b to TRP 2 over uplink channel 240-b in accordance with the second PDCCH order 255-b. Each Msg1 245 may include a RACH preamble and be transmitted on a RACH occasion which indicates a beam for transmission and an RA-RNTI.

The MAC entity 210 at the UE 115-a may update the values of the counters based on the status of the random access procedure. For example, the MAC entity 210 may increment the preamble transmission counter by 1 on each RACH occasion of the RACH procedure. In some implementations, the UE 115-a may change the spatial domain transmission filter of the beam configuration prior to a PRACH retransmission. As such, the PHY layer 205 may send a layer 1 message 230 which indicates the change of the spatial domain transmission filter of the beam configuration. The MAC entity 210 may then suspend the power ramp counter. Alternatively, the MAC entity 210 may increment the power ramp counter by one if the MAC entity 210 determines that the UE 115-a has not changed the spatial domain transmission filter of the beam configuration. The MAC entity 210 may set the preamble received target power based on the preamble transmission counter and the power ramp counter. The MAC entity 210 may send an instruction message 235 that includes an indication of the preamble received target power and instructions for the PHY layer 205 to transmit a PRACH using the corresponding preamble received target power.

In some implementations, the UE 115-a may receive a random access response which includes a PDCCH 260 and a PDSCH 265 transmitted from a serving cell of the TRP. For example, the UE 115-a may receive the PDCCH 260-a and the PDSCH 265-a from a serving cell of TRP 1. Similarly, the UE 115-a may receive the PDCCH 260-b and the PDSCH 265-b from a serving cell of TRP 2. Each PDCCH 260 may include a MAC subPDU with a scrambled RA-RNTI associated with the RACH procedure. The PHY layer 205 may send a PDSCH indication 225 to the MAC entity 210 which may include the full or partial PDSCH 265. If the random access response is successfully decoded and the RA-RNTI corresponds to the transmitted preamble index, the UE 115-a may consider the random access response reception as successful.

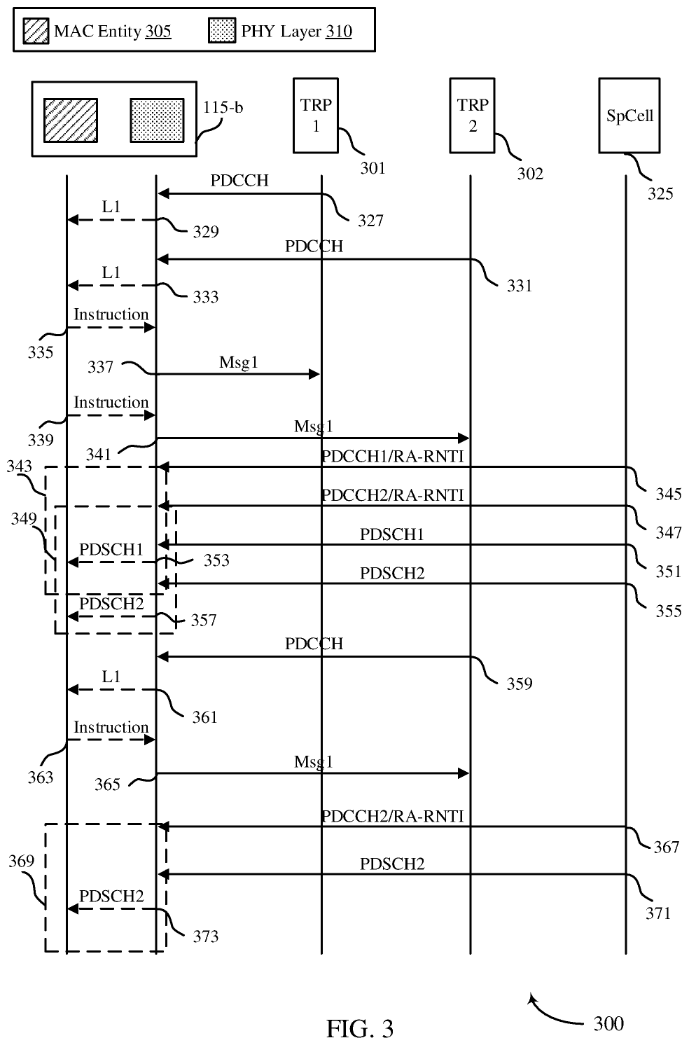

FIG. 3 illustrates an example of a process flow 300 that supports uplink power control for multiple RACH procedures in accordance with one or more aspects of the present disclosure. In some examples, the process flow 300 may implement or be implemented by aspects of the wireless communication systems 100 and 200 as described with reference to FIGS. 1 and 2, respectively. For example, the process flow 300 may be implemented by a first TRP (TRP 1 301), a second TRP (TRP 2 302), a UE 115-b, and a serving cell 325, which may be an example of a network entity 105, as described with reference to FIGS. 1 and 2, respectively. The process flow 300 may be implemented by UE 115-b, TRP 1 301, TRP 2 302, and serving cell 325 to exchange signaling to promote fast uplink synchronization at UE 115-b.

In the following description of the process flow 300, the operations between UE 115-b, TRP 1 301, TRP 2 302, and the serving cell 325 may be transmitted in a different order than the example order shown, or the operations performed may be performed in different orders or at different times. Some operations may also be omitted from the process flow 300, and other operations may be added to the process flow 300.

In some implementations, multiple parallel PRACH procedures may be triggered by corresponding to PDCCH orders associated with different control resource set pool indexes on the same CC. For example, a MAC entity 305 at the UE 115-b and a physical (PHY) layer 310 at the UE 115-b may communicate with TRP 1 and TRP 2 on the same serving cell, and each TRP may correspond to a different control resource set pool index. The serving cell 325 may be configured with a single timing advance group.

At 327, TRP 1 may transmit a PDCCH order to the PHY layer 310 which may be associated with a control resource set pool index of TRP 1 and indicates the start of a RACH procedure. At 329, the PHY layer 310 may notify the MAC entity 305 of the start of the RACH procedure by sending a layer 1 message which includes an indication of the control resource set pool index of TRP 1. Accordingly, the MAC entity 305 may initialize a preamble transmission counter and a preamble power ramping counter associated with the control resource set pool index of TRP 1. Each counter may be initialized to 1.

At 331, TRP 2 may transmit a PDCCH order to PHY layer 310 which may be associated with a control resource set pool index of TRP 2 and indicates the start of a second RACH procedure that temporally overlaps with the first RACH procedure. At 333, the PHY layer 310 may notify the MAC entity 305 of the start of the RACH procedure by sending a layer 1 message which includes an indication of the control resource set pool index of TRP 2. Accordingly, the MAC entity 305 may initialize a preamble transmission counter and a preamble power ramping counter associated with the control resource set pool index of TRP 2. Each counter may be initialized to 1.

At 335, the MAC entity 305 may set a target reception power for the first RACH procedure based on the preamble transmission counter and preamble power ramping counter associated with TRP 1, and may send an instruction message associated with the RACH occasion of TRP 1 to the PHY layer 310. The instruction message may include the preamble received target power corresponding to TRP 1, the value of the preamble transmission counter, the value of the preamble power ramping counter, of any combination thereof. Additionally or alternatively, the MAC entity 305 may instruct the PHY layer 310 to transmit a first RACH preamble based on the target reception power.

At 337, the PHY layer 310 may transmit Msg1 to TRP 1 using a transmission power determined in part by the preamble received target power. Msg1 may communicate a RACH preamble in a RACH occasion which may determine an RA-RNTI corresponding to TRP 1.

At 339, the MAC entity 305 may set a target reception power for the second RACH procedure based on the preamble transmission counter and preamble power ramping counter associated with TRP 2, and may send an instruction message associated with the RACH occasion of TRP 2 to the PHY layer 310. The instruction message may include the preamble received target power corresponding to TRP 2, the value of the preamble transmission counter, the value of the preamble power ramping counter, of any combination thereof. Additionally or alternatively, the MAC entity 305 may instruct the PHY layer 310 to transmit a second RACH preamble based on the target reception power.

At 341, the PHY layer 310 may transmit Msg1 to TRP 2 using a transmission power determined in part by the preamble received target power. Msg1 may communicate a RACH preamble in a RACH occasion which may determine an RA-RNTI corresponding to TRP 2. The UE 115-b may initiate a random access response window 343 corresponding to TRP 1 in response transmitting the Msg1 of the RACH procedure at 337. The random access response window 343 may define a time period during which UE 115-b may monitor for downlink transmissions from TRP 1.

The UE 115-b may initiate a random access response window 349 corresponding to TRP 2 in response to receiving the first PDDCH of the RACH procedure at 331. The random access response window 349 may define a time period during which UE 115-b may monitor for downlink transmissions from TRP 2.

At 345, the serving cell 325 may transmit a PDCCH (e.g., Msg2) which is scrambled by a RA-RNTI associated with the RACH occasion of Msg1 towards TRP 1. In some examples, the serving cell 325 may transmit the PDCCH via TRP 1. At 347, the serving cell 325 may transmit a PDCCH which is scrambled by a RA-RNTI associated with the RACH occasion of Msg1 towards TRP 2. In some examples, the serving cell 325 may transmit the PDCCH via TRP 2.

At 351, the serving cell 325 may transmit a PDSCH1 corresponding to TRP 1 to the UE 115-b at the PHY layer 310. At 353, the PHY layer 310 may send an indication of the PDSCH1 to the MAC entity 305 if the PDSCH1 at 351 was successfully received and decode during the random access response window 343. In some cases, the indication may include a full PDSCH and in other cases the indication may include a partial PDSCH. Upon successful receipt of the PDSCH1 at 353, the random access preamble identifier included in PDSCH1 matches the random access preamble index of Msg1 transmitted at 337. The MAC entity 305 may determine that the RACH procedure is successfully complete and reset the counters associated with TRP 1.

At 355, the serving cell 325 may transmit a PDSCH2 corresponding to TRP 2 to the UE 115-b at the PHY layer 310. The MAC entity 305 may monitor for a PDSCH during the response window 349, however, in some cases, the MAC entity 305 may not receive an indication at 357 because the PHY layer 310 may not receive the PDSCH2 transmitted at 355. In other cases, the random access preamble identifier included in PDSCH2 transmitted at 355 may not match the RACH preamble index of Msg1 transmitted at 341. If the response window 349 expires and a random access response containing RACH preamble identifiers that matches the transmitted preamble index has not been received, the MAC entity 305 may consider the RACH transmission unsuccessful and increment the preamble transmission counter associated with TRP 2.

At 359, TRP 2 may initiate retransmission by transmitting a PDCCH order to the PHY layer 310. In some cases, the PHY layer 310 may determine at 361 that the beam associated with the uplink RACH message is different from the beam associated with the previous uplink RACH message transmitted at 341. The PHY layer 310 may accordingly send a layer 1 message to the MAC entity 305 indicating for the MAC entity 305 to suspend the value of the preamble power ramping counter.

Alternatively, the PHY layer 310 may determine at 361 that the beam associated with the uplink RACH message is the same as the beam associated with the previous uplink RACH message transmitted at 341. In this case, the PHY layer 310 may refrain from sending a layer 1 message to the MAC entity 305 at 361 or a second layer 1 message to the MAC entity 305 indicating for the MAC entity 305 to increment the value of the preamble power ramping counter. If the MAC entity 305 may not receive a notification to suspend the power ramping counter or receive a notification to increment the power ramping counter prior to the PRACH retransmission, the MAC entity 305 may increment the value of the preamble power ramping counter.

At 363, the MAC entity 305 may set a target reception power for the RACH procedure based on the preamble transmission counter and preamble power ramping counter associated with TRP 2, and may send an instruction message associated with the RACH occasion of TRP 2 to the PHY layer 310. The instruction message may include the preamble received target power corresponding to TRP 2, the value of the preamble transmission counter, the value of the preamble power ramping counter, of any combination thereof. Additionally or alternatively, the MAC entity 305 may instruct the PHY layer 310 to transmit a RACH preamble based on the target reception power. In some cases, the preamble transmission counter value may exceed a pre-determined threshold value in which case the MAC entity 305 may determine that the RACH procedure is complete, reset the counters, and send an instruction at 363 indicating that the RACH procedure is complete.

At 365, the PHY layer 310 may transmit Msg1 to TRP 2 using a transmission power determined in part by the preamble received target power. The RACH occasion of Msg1 may determine a RA-RNTI corresponding to TRP 2. The UE 115-b may initiate a random access response window 369 corresponding to TRP 2 in response to transmitting Msg1 of the RACH procedure at 365. The random access response window 369 may define a time period during which UE 115-b may monitor for downlink transmissions from TRP 2.

At 367, the serving cell 325 may transmit a PDCCH which is scrambled by a RA-RNTI associated with TRP 2. At 371, the serving cell 325 may transmit a PDSCH2 corresponding to TRP 2 to the PHY layer 310. At 373, the PHY layer 310 may send an indication of the PDSCH2 to the MAC entity 305 if the PDSCH2 at 373 was successfully received and decoded during the random access response window 369. In some cases, the indication may be a full PDSCH and in other cases the indication of receipt of PDSCH. Upon successful receipt of the PDSCH2 at 373, the random access preamble identifier included in PDSCH2 matches the random access preamble index of Msg1 transmitted at 365. The MAC entity 305 may determine that the RACH procedure is successfully complete and reset the counters associated with TRP 2.

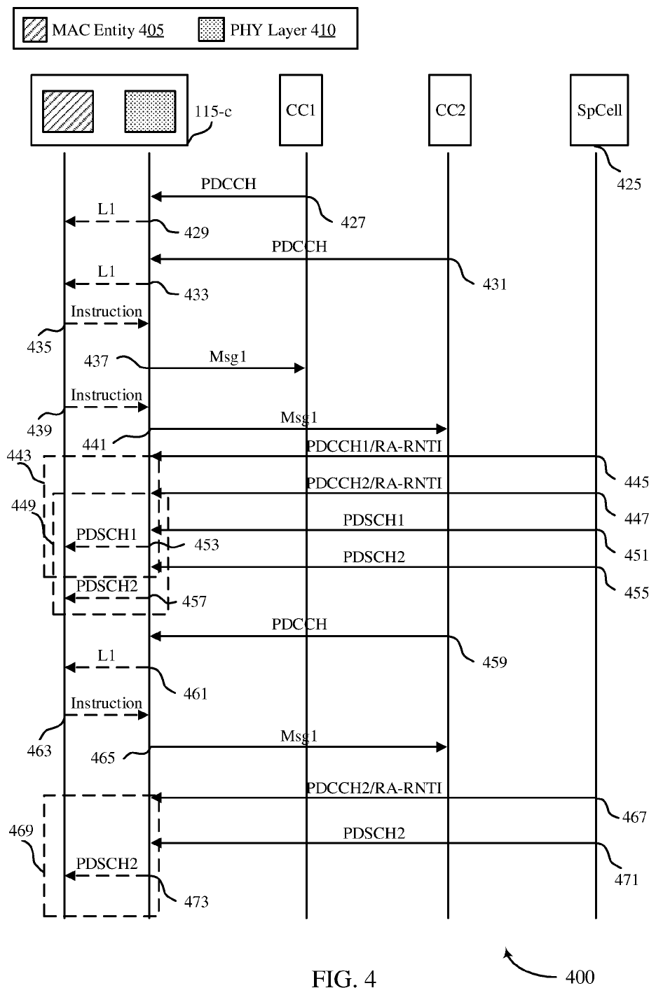

FIG. 4 illustrates an example of a process flow 400 that supports uplink power control for multiple RACH procedures in accordance with one or more aspects of the present disclosure. In some examples, the process flow 400 may implement or be implemented by aspects of the wireless communication systems 100 and 200 as described with reference to FIGS. 1 and 2, respectively. For example, the process flow 400 may be implemented by a first CC, a second CC, a UE 115-c, and a serving cell 325, which may be an example of a network entity 105 as described with reference to FIGS. 1 and 2, respectively. The process flow 400 may be implemented by UE 115-c, CC1, CC2, and serving cell 425 to exchange signaling to promote fast uplink synchronization at UE 115-c. In the following description of the process flow 400, the operations between UE 115-c, CC1, CC2, and the serving cell 425 may be transmitted in a different order than the example order shown, or the operations performed may be performed in different orders or at different times. Some operations may also be omitted from the process flow 400, and other operations may be added to the process flow 400.

In some implementations, multiple parallel PRACH procedures may be triggered by multiple PDCCH orders for one or more serving cells belonging to different timing advance groups. For example, a MAC entity 405 at UE 115-c and a physical (PHY) layer 410 at UE 115-c may communicate with a first TRP having associated with a first CC (CC1) and a second TRP associated with a second CC (CC2). Each TRP may belong to a different timing advance group. Additionally or alternatively, multiple TRPs may exist within a timing advance group.

At 427, a TRP associated with CC1 may transmit a PDCCH order to the PHY layer 410. The PDCCH order may include an indication of a timing advance group associated with CC1 and may indicate a start of a RACH procedure. At 429, the PHY layer 410 may notify the MAC entity 405 of the start of the RACH procedure by sending a layer 1 message which includes an indication of the timing advance group associated with CC1. Accordingly, the MAC entity 405 may initialize a preamble transmission counter and a preamble power ramping counter associated with the timing advance group of CC1. Each counter may be initialized to 1.

At 431, a TRP associated with CC2 may transmit a PDCCH order to PHY layer 410. In some examples, the PDCCH order may include a timing advance group associated with CC2 and may indicate the start of a second RACH procedure that temporally overlaps with the first RACH procedure. At 433, the PHY layer 410 may notify the MAC entity 405 of the start of the RACH procedure by sending a layer 1 message which includes an indication of the timing advance group associated with CC2. Accordingly, the MAC entity 405 may initialize a preamble transmission counter and a preamble power ramping counter associated with the timing advance group of CC2. Each counter may be initialized to 1.

At 435, the MAC entity 405 may set a target reception power for the first RACH procedure based on the preamble transmission counter and preamble power ramping counter associated with CC1, and send an instruction message associated with the RACH occasion of CC1 to the PHY layer 410. The instruction message may include the preamble received target power corresponding to CC1, the value of the preamble transmission counter, the value of the preamble power ramping counter, or any combination thereof. Additionally or alternatively, the MAC entity 405 may instruct the PHY layer 410 to transmit a first RACH preamble based on the target reception power.

At 437, the PHY layer 410 may transmit Msg1 to CC1 using a transmission power determined in part by the preamble received target power. Msg1 may communicate a RACH preamble in a RACH occasion which may determine a RA-RNTI corresponding to CC1. At 439, the MAC entity 405 may set a target reception power for the second RACH procedure based on the preamble transmission counter and preamble power ramping counter associated with CC2, and may send an instruction message associated with the RACH occasion of CC2 to the PHY layer 410. The instruction message may include the preamble received target power corresponding to CC2, the value of the preamble transmission counter, the value of the preamble power ramping counter, of any combination thereof. Additionally or alternatively, the MAC entity 405 may instruct the PHY layer 410 to transmit a second RACH preamble based on the target reception power.

At 441, the PHY layer 410 may transmit Msg1 to CC2 using a transmission power determined in part by the preamble received target power. Msg1 may communicate a RACH preamble in a RACH occasion which may determine a RA-RNTI corresponding to CC2. The UE 115-c may initiate a random access response window 443 corresponding to CC1 in response to transmitting the Msg1 of the RACH procedure at 437. The random access response window 443 may define a time period during which UE 115-c may monitor for downlink transmissions from CC1. The UE 115-c may initiate a random access response window 449 corresponding to CC2 in response to transmitting the Msg1 of the RACH procedure at 441. The random access response window 449 may define a time period during which the UE 115-c may monitor for downlink transmissions from CC2.

At 445, the serving cell 425 may transmit a PDCCH (e.g., Msg2) which is scrambled by a RA-RNTI associated with CC1. At 447, the serving cell 425 may transmit a PDCCH which is scrambled by a RA-RNTI associated with CC2.

At 451, the serving cell 425 may transmit a PDSCH1 corresponding to CC1 to the PHY layer 410. At 453, the PHY layer 410 may send an indication of the PDSCH1 to the MAC entity 405 if the PDSCH1 at 451 was successfully received and decoded during the random access response window 443. In some cases, the indication may include an indication of PDSCH or the full PDSCH. Upon successful receipt of the PDSCH1 at 453, the random access preamble identifier included in the PDSCH1 matches the random access preamble index Msg1 transmitted at 437. The MAC entity 405 may determine that the RACH procedure is successfully complete and reset the counters associated with CC1.

At 455, the serving cell 425 may transmit a PDSCH2 corresponding to CC2 to the PHY layer 410. The MAC entity 405 may monitor for a PDSCH during the response window 449. However, in some cases, the MAC entity 405 may not receive an indication at 457 because the PHY layer 410 may not have received the PDSCH2 transmitted at 455. In other cases, the random access preamble identifier included in PDSCH2 transmitted at 455 may not match the RACH preamble index included in the Msg1 transmitted at 441. If the response window 449 expires and a random access response containing RACH preamble identifiers that matches the transmitted preamble index has not been received, the MAC entity 405 may consider the RACH transmission unsuccessful and increment the preamble transmission counter associated with CC2.

At 459, CC2 may initiate retransmission by transmitting a PDCCH order to the PHY layer 410. In some cases, the PHY layer 410 may determine at 461 that the beam associated with the uplink RACH message is different from the beam associated with the previous uplink RACH message transmitted at 431. The PHY layer 410 may accordingly send a layer 1 message to the MAC entity 405 indicating for the MAC entity 405 to suspend the value of the preamble power ramping counter.

Alternatively, the PHY layer 410 may determine at 461 that the beam associated with the uplink RACH message is the same as the beam associated with the previous uplink RACH message transmitted at 431. In this case, the PHY layer 410 may not send a layer 1 message to the MAC entity 405 at 461. If the MAC entity 405 does not receive a notification to suspend the power ramping counter or receive a notification to increment the power ramping counter prior to the PRACH retransmission, the MAC entity 405 may increment the value of the preamble power ramping counter.

At 463, the MAC entity 405 may set a target reception power for the RACH procedure based on the preamble transmission counter and preamble power ramping counter associated with CC2, and send an instruction message associated with the RACH occasion of CC2 to the PHY layer 410. The instruction message may include the preamble received target power corresponding to CC2, the value of the preamble transmission counter, the value of the preamble power ramping counter, or any combination thereof. Additionally or alternatively, the MAC entity 405 may instruct the PHY layer 410 to transmit a RACH preamble based on the target reception power. In some cases, the preamble transmission counter value may exceed a pre-determined threshold value in which case the MAC entity 405 may determine that the RACH procedure is complete, reset the counters, and send an instruction at 463 indicating that the RACH procedure is complete.

At 465, the PHY layer 410 may transmit Msg1 to CC2 using a transmission power determined in part by the preamble received target power. The RACH occasion of Msg1 may determine a RA-RNTI corresponding to CC2. The UE 115-c may initiate a random access response window 469 corresponding to CC2 in response to transmitting the Msg1 of the RACH procedure at 465. The random access response window 469 may define a time period during which UE 115b may monitor for downlink transmissions from CC2.

At 467, the serving cell 325 may transmit a PDCCH which is scrambled by a RA-RNTI associated with CC2. At 471, the serving cell 425 may transmit a PDSCH2 corresponding to CC2 to the PHY layer 410. At 473, the PHY layer 410 may send an indication of the PDSCH2 to the MAC entity 405 if the PDSCH2 at 473 was successfully received and decoded during the random access response window 469. In some cases, the indication may be a full PDSCH and in other cases the indication may be a partial PDSCH. Upon successful receipt of the PDSCH2 at 473 and provided that the random access preamble identifier included in PDSCH2 matches the random access preamble index of Msg1 transmitted at 465, the MAC entity 405 may determine that the RACH procedure is successfully complete and reset the counters associated with CC2.

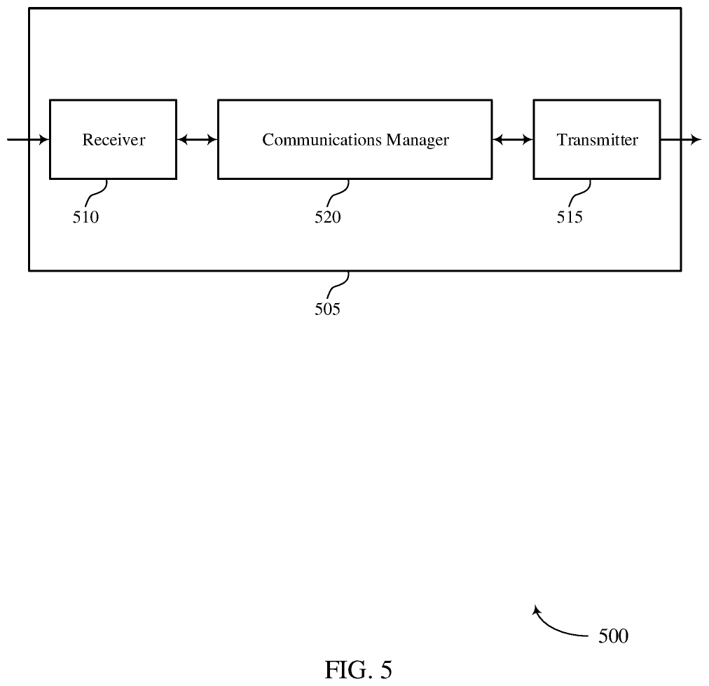

FIG. 5 shows a block diagram 500 of a device 505 that supports uplink power control for multiple RACH procedures in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to uplink power control for multiple RACH procedures). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to uplink power control for multiple RACH procedures). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of uplink power control for multiple RACH procedures as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communication at a UE in accordance with examples as disclosed herein. For example, the communications manager 520 may be configured as or otherwise support a means for receiving a first downlink control channel order triggering a first random access procedure and a second downlink control channel order triggering a second random access procedure that temporally overlaps with the first random access procedure. The communications manager 520 may be configured as or otherwise support a means for initiating a first set of counters associated with uplink power control for the first random access procedure and a second set of counters associated with uplink power control for the second random access procedure. The communications manager 520 may be configured as or otherwise support a means for transmitting a first uplink RACH message in accordance with the first downlink control channel order and a second uplink RACH message in accordance with the second downlink control channel order. The communications manager 520 may be configured as or otherwise support a means for updating values of the first set of counters based on a first status of the first random access procedure and values of the second set of counters based on a second status of the second random access procedure.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for reduced processing, reduced power consumption, and more efficient utilization of communication resources.

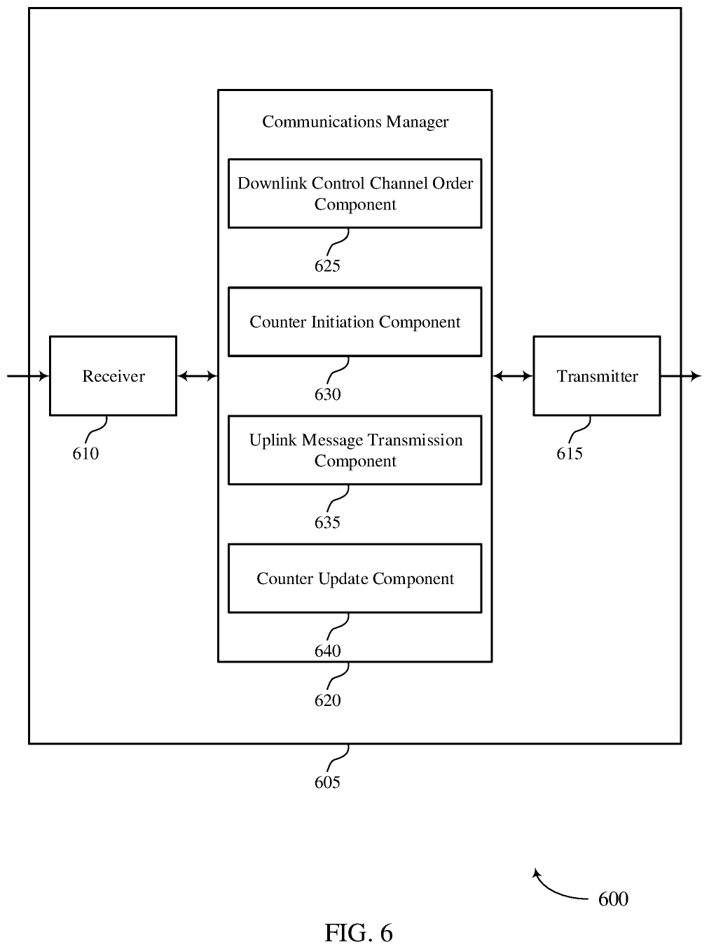

FIG. 6 shows a block diagram 600 of a device 605 that supports uplink power control for multiple RACH procedures in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to uplink power control for multiple RACH procedures). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to uplink power control for multiple RACH procedures). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of uplink power control for multiple RACH procedures as described herein. For example, the communications manager 620 may include a downlink control channel order component 625, a counter initiation component 630, an uplink message transmission component 635, a counter update component 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. The downlink control channel order component 625 may be configured as or otherwise support a means for receiving a first downlink control channel order triggering a first random access procedure and a second downlink control channel order triggering a second random access procedure that temporally overlaps with the first random access procedure. The counter initiation component 630 may be configured as or otherwise support a means for initiating a first set of counters associated with uplink power control for the first random access procedure and a second set of counters associated with uplink power control for the second random access procedure. The uplink message transmission component 635 may be configured as or otherwise support a means for transmitting a first uplink RACH message in accordance with the first downlink control channel order and a second uplink RACH message in accordance with the second downlink control channel order. The counter update component 640 may be configured as or otherwise support a means for updating values of the first set of counters based on a first status of the first random access procedure and values of the second set of counters based on a second status of the second random access procedure.

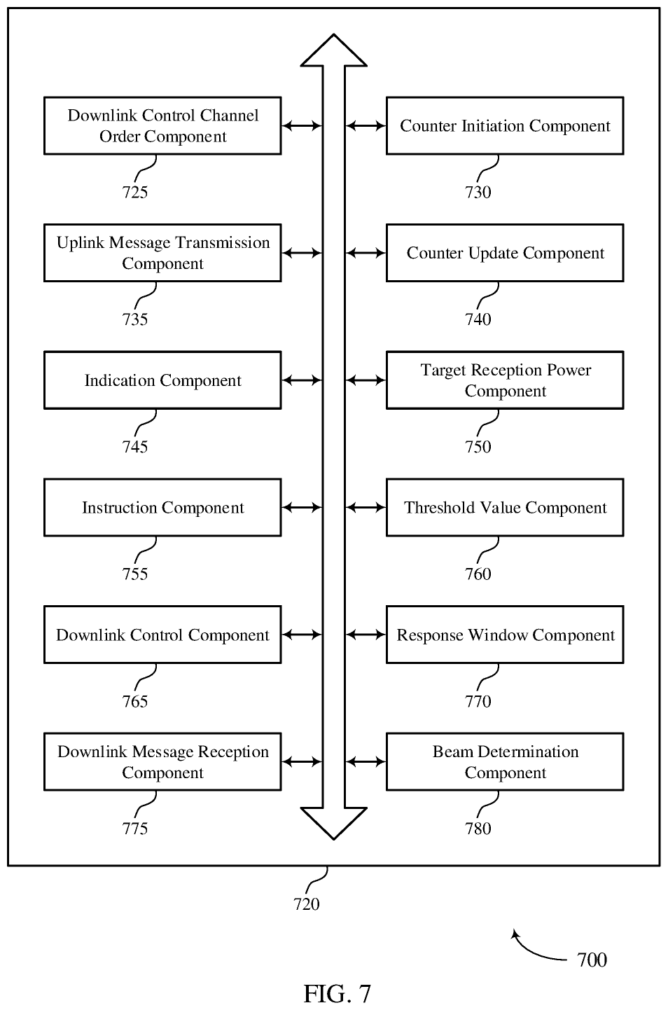

FIG. 7 shows a block diagram 700 of a communications manager 720 that supports uplink power control for multiple RACH procedures in accordance with one or more aspects of the present disclosure. The communications manager 720 may be an example of aspects of a communications manager 520, a communications manager 620, or both, as described herein. The communications manager 720, or various components thereof, may be an example of means for performing various aspects of uplink power control for multiple RACH procedures as described herein. For example, the communications manager 720 may include a downlink control channel order component 725, a counter initiation component 730, an uplink message transmission component 735, a counter update component 740, an indication component 745, a target reception power component 750, an instruction component 755, a threshold value component 760, a downlink control component 765, a response window component 770, a downlink message reception component 775, a beam determination component 780, or any combination thereof. Each of these components may communicate, directly or indirectly, with one another (e.g., via one or more buses).

The communications manager 720 may support wireless communication at a UE in accordance with examples as disclosed herein. The downlink control channel order component 725 may be configured as or otherwise support a means for receiving a first downlink control channel order triggering a first random access procedure and a second downlink control channel order triggering a second random access procedure that temporally overlaps with the first random access procedure. The counter initiation component 730 may be configured as or otherwise support a means for initiating a first set of counters associated with uplink power control for the first random access procedure and a second set of counters associated with uplink power control for the second random access procedure. The uplink message transmission component 735 may be configured as or otherwise support a means for transmitting a first uplink RACH message in accordance with the first downlink control channel order and a second uplink RACH message in accordance with the second downlink control channel order. The counter update component 740 may be configured as or otherwise support a means for updating values of the first set of counters based on a first status of the first random access procedure and values of the second set of counters based on a second status of the second random access procedure.

In some examples, to support receiving the first downlink control channel order and the second downlink control channel order, the downlink control channel order component 725 may be configured as or otherwise support a means for receiving the first downlink control channel order associated with a first control resource set pool index value. In some examples, to support receiving the first downlink control channel order and the second downlink control channel order, the downlink control channel order component 725 may be configured as or otherwise support a means for receiving the second downlink control channel order associated with a second control resource set pool index value different from the first control resource set pool index value.

In some examples, to support receiving the first downlink control channel order and the second downlink control channel order, the downlink control channel order component 725 may be configured as or otherwise support a means for receiving the first downlink control channel order associated with a first timing advance group. In some examples, to support receiving the first downlink control channel order and the second downlink control channel order, the downlink control channel order component 725 may be configured as or otherwise support a means for receiving the second downlink control channel order associated with a second timing advance group different from the first timing advance group.

In some examples, the indication component 745 may be configured as or otherwise support a means for sending, from a physical layer at the UE to a MAC layer at the UE, an indication of the first random access procedure and the second random access procedure. In some examples, the target reception power component 750 may be configured as or otherwise support a means for setting, at the MAC layer at the UE, a first random access target reception power for the first random access procedure based on the first set of counters and a second random access target reception power for the second random access procedure based on the second set of counters. In some examples, the instruction component 755 may be configured as or otherwise support a means for instructing, the physical layer at the UE, to transmit a first random access preamble based on the first random access target reception power and a second random access preamble based on the second random access target reception power.

In some examples, the first set of counters includes a first preamble transmission counter associated with the first random access procedure and a first preamble power ramping counter associated with the first random access procedure, and the second set of counters includes a second preamble transmission counter associated with the second random access procedure and a second preamble power ramping counter associated with the second random access procedure.

In some examples, the threshold value component 760 may be configured as or otherwise support a means for receiving an indication of a first threshold value associated with a first preamble transmission counter in the first set of counters and a second threshold value associated with a second preamble transmission counter in the second set of counters, where the first set of counters and the second set of counters are updated based on the first threshold value and the second threshold value.

In some examples, the counter update component 740 may be configured as or otherwise support a means for resetting the values of the first set of counters based on the first random access procedure being successful. In some examples, the counter update component 740 may be configured as or otherwise support a means for incrementing the values of the second set of counters based on the second random access procedure being unsuccessful.

In some examples, the downlink control component 765 may be configured as or otherwise support a means for receiving a first downlink control message of the first random access procedure in response to the first uplink RACH message. In some examples, the downlink control component 765 may be configured as or otherwise support a means for receiving a first downlink control message of the second random access procedure in response to the second uplink RACH message. In some examples, the response window component 770 may be configured as or otherwise support a means for initiating a first response window in response to receiving the first downlink control message of the first random access procedure. In some examples, the response window component 770 may be configured as or otherwise support a means for initiating a second response window in response to receiving the first downlink control message of the second random access procedure, where the first response window and the second response window are independent of each other.

In some examples, the downlink message reception component 775 may be configured as or otherwise support a means for receiving a second downlink message of the first random access procedure within the first response window. In some examples, the counter update component 740 may be configured as or otherwise support a means for incrementing the value of a preamble transmission counter in the second set of counters based on an expiration of the second response window prior to reception of a second downlink message of the second random access procedure.

In some examples, incrementing the value of a preamble power ramping counter in the second set of counters is based on signaling from a physical layer at the UE to a MAC layer at the UE. In some examples, the downlink control channel order component 725 may be configured as or otherwise support a means for receiving a third downlink control channel order triggering a second attempt of the second random access procedure based on a first attempt of the second random access procedure being unsuccessful. In some examples, the uplink message transmission component 735 may be configured as or otherwise support a means for transmitting a third uplink RACH message in accordance with the third downlink control channel order triggering the second random access procedure.

In some examples, the beam determination component 780 may be configured as or otherwise support a means for determining, at a physical layer at the UE, that a beam associated with the third uplink RACH message is the same as a beam associated with the second uplink RACH message. In some examples, the indication component 745 may be configured as or otherwise support a means for notifying, a MAC layer at the UE, to increment the value of a preamble power ramping counter in the second set of counters based on the determination. In some examples, the counter update component 740 may be configured as or otherwise support a means for incrementing, at the MAC layer at the UE, the value of the preamble power ramping counter in the second set of counters based on the notifying.

In some examples, the beam determination component 780 may be configured as or otherwise support a means for determining, at a physical layer at the UE, that a beam associated with the third uplink RACH message is different from a beam associated with the second uplink RACH message. In some examples, the indication component 745 may be configured as or otherwise support a means for notifying, a MAC layer at the UE, to suspend the value of a preamble power ramping counter in the second set of counters based on the determination. In some examples, the counter update component 740 may be configured as or otherwise support a means for suspending, at the MAC layer at the UE, the value of the preamble power ramping counter in the second set of counters based on the notifying.

In some examples, the first downlink control channel order is associated with a first TRP and the second downlink control channel order is associated with a second TRP. In some examples, the first downlink control channel order is associated with a first CC associated with at least a first timing advance group and the second downlink control channel order is associated with a second CC associated with at least a second timing advance group different from the first timing advance group.

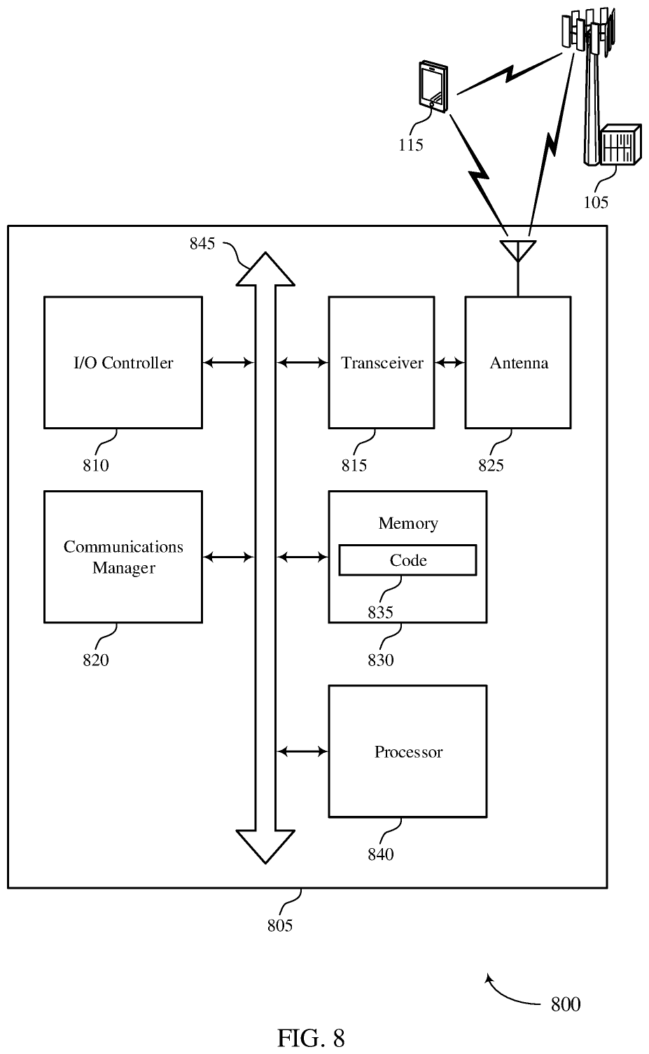

FIG. 8 shows a diagram of a system 800 including a device 805 that supports uplink power control for multiple RACH procedures in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting uplink power control for multiple RACH procedures). For example, the device 805 or a component of the device 805 may include a processor 840 and memory 830 coupled with or to the processor 840, the processor 840 and memory 830 configured to perform various functions described herein.

The communications manager 820 may support wireless communication at a UE in accordance with examples as disclosed herein. For example, the communications manager 820 may be configured as or otherwise support a means for receiving a first downlink control channel order triggering a first random access procedure and a second downlink control channel order triggering a second random access procedure that temporally overlaps with the first random access procedure. The communications manager 820 may be configured as or otherwise support a means for initiating a first set of counters associated with uplink power control for the first random access procedure and a second set of counters associated with uplink power control for the second random access procedure. The communications manager 820 may be configured as or otherwise support a means for transmitting a first uplink RACH message in accordance with the first downlink control channel order and a second uplink RACH message in accordance with the second downlink control channel order. The communications manager 820 may be configured as or otherwise support a means for updating values of the first set of counters based on a first status of the first random access procedure and values of the second set of counters based on a second status of the second random access procedure.

By including or configuring the communications manager 820 in accordance with examples as described herein, the device 805 may support techniques for improved communication reliability, reduced latency, improved user experience related to reduced processing, reduced power consumption, more efficient utilization of communication resources, and improved coordination between devices.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of uplink power control for multiple RACH procedures as described herein, or the processor 840 and the memory 830 may be otherwise configured to perform or support such operations.

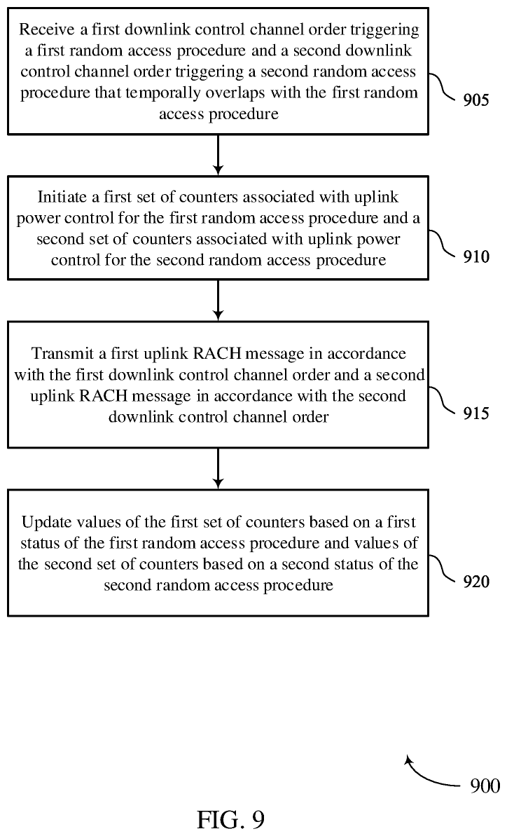

FIG. 9 shows a flowchart illustrating a method 900 that supports uplink power control for multiple RACH procedures in accordance with one or more aspects of the present disclosure. The operations of the method 900 may be implemented by a UE or its components as described herein. For example, the operations of the method 900 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 905, the method may include receiving a first downlink control channel order triggering a first random access procedure and a second downlink control channel order triggering a second random access procedure that temporally overlaps with the first random access procedure. The operations of 905 may be performed in accordance with examples as disclosed herein. In some examples, aspects of the operations of 905 may be performed by a downlink control channel order component 725 as described with reference to FIG. 7.

At 910, the method may include initiating a first set of counters associated with uplink power control for the first random access procedure and a second set of counters associated with uplink power control for the second random access procedure. The operations of 910 may be performed in accordance with examples as disclosed herein. In some examples, aspects of the operations of 910 may be performed by a counter initiation component 730 as described with reference to FIG. 7.

At 915, the method may include transmitting a first uplink RACH message in accordance with the first downlink control channel order and a second uplink RACH message in accordance with the second downlink control channel order. The operations of 915 may be performed in accordance with examples as disclosed herein. In some examples, aspects of the operations of 915 may be performed by an uplink message transmission component 735 as described with reference to FIG. 7.

At 920, the method may include updating values of the first set of counters based on a first status of the first random access procedure and values of the second set of counters based on a second status of the second random access procedure. The operations of 920 may be performed in accordance with examples as disclosed herein. In some examples, aspects of the operations of 920 may be performed by a counter update component 740 as described with reference to FIG. 7.

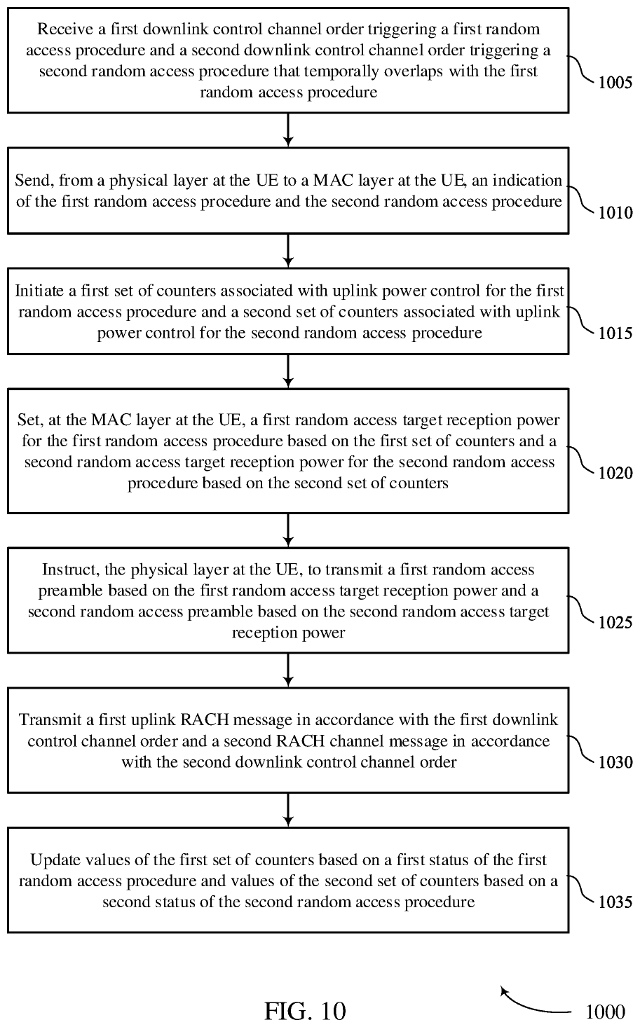

FIG. 10 shows a flowchart illustrating a method 1000 that supports uplink power control for multiple RACH procedures in accordance with one or more aspects of the present disclosure. The operations of the method 1000 may be implemented by a UE or its components as described herein. For example, the operations of the method 1000 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1005, the method may include receiving a first downlink control channel order triggering a first random access procedure and a second downlink control channel order triggering a second random access procedure that temporally overlaps with the first random access procedure. The operations of 1005 may be performed in accordance with examples as disclosed herein. In some examples, aspects of the operations of 1005 may be performed by a downlink control channel order component 725 as described with reference to FIG. 7.

At 1010, the method may include sending, from a physical layer at the UE to a MAC layer at the UE, an indication of the first random access procedure and the second random access procedure. The operations of 1010 may be performed in accordance with examples as disclosed herein. In some examples, aspects of the operations of 1010 may be performed by an indication component 745 as described with reference to FIG. 7.

At 1015, the method may include initiating a first set of counters associated with uplink power control for the first random access procedure and a second set of counters associated with uplink power control for the second random access procedure. The operations of 1015 may be performed in accordance with examples as disclosed herein. In some examples, aspects of the operations of 1015 may be performed by a counter initiation component 730 as described with reference to FIG. 7.

At 1020, the method may include setting, at the MAC layer at the UE, a first random access target reception power for the first random access procedure based on the first set of counters and a second random access target reception power for the second random access procedure based on the second set of counters. The operations of 1020 may be performed in accordance with examples as disclosed herein. In some examples, aspects of the operations of 1020 may be performed by a target reception power component 750 as described with reference to FIG. 7.

At 1025, the method may include instructing, the physical layer at the UE, to transmit a first random access preamble based on the first random access target reception power and a second random access preamble based on the second random access target reception power. The operations of 1025 may be performed in accordance with examples as disclosed herein. In some examples, aspects of the operations of 1025 may be performed by an instruction component 755 as described with reference to FIG. 7.

At 1030, the method may include transmitting a first uplink RACH message in accordance with the first downlink control channel order and a second RACH channel message in accordance with the second downlink control channel order. The operations of 1030 may be performed in accordance with examples as disclosed herein. In some examples, aspects of the operations of 1030 may be performed by an uplink message transmission component 735 as described with reference to FIG. 7.

At 1035, the method may include updating values of the first set of counters based on a first status of the first random access procedure and values of the second set of counters based on a second status of the second random access procedure. The operations of 1035 may be performed in accordance with examples as disclosed herein. In some examples, aspects of the operations of 1035 may be performed by a counter update component 740 as described with reference to FIG. 7.

The following provides an overview of aspects of the present disclosure:

Aspect 1: A method for wireless communication at a UE, comprising: receiving a first downlink control channel order triggering a first random access procedure and a second downlink control channel order triggering a second random access procedure that temporally overlaps with the first random access procedure; initiating a first set of counters associated with uplink power control for the first random access procedure and a second set of counters associated with uplink power control for the second random access procedure; and transmitting a first uplink random access channel message in accordance with the first downlink control channel order and a second uplink random access channel message in accordance with the second downlink control channel order; and updating values of the first set of counters based at least in part on a first status of the first random access procedure and values of the second set of counters based at least in part on a second status of the second random access procedure.

Aspect 2: The method of aspect 1, wherein receiving the first downlink control channel order and the second downlink control channel order comprises: receiving the first downlink control channel order associated with a first control resource set pool index value; and receiving the second downlink control channel order associated with a second control resource set pool index value different from the first control resource set pool index value.

Aspect 3: The method of any of aspects 1 through 2, wherein receiving the first downlink control channel order and the second downlink control channel order comprises: receiving the first downlink control channel order associated with a first timing advance group; and receiving the second downlink control channel order associated with a second timing advance group different from the first timing advance group.

Aspect 4: The method of any of aspects 1 through 3, further comprising: sending, from a physical layer at the UE to a medium access control layer at the UE, an indication of the first random access procedure and the second random access procedure; setting, at the medium access control layer at the UE, a first random access target reception power for the first random access procedure based at least in part on the first set of counters and a second random access target reception power for the second random access procedure based at least in part on the second set of counters; and instructing, the physical layer at the UE, to transmit a first random access preamble based at least in part on the first random access target reception power and a second random access preamble based at least in part on the second random access target reception power.

Aspect 5: The method of any of aspects 1 through 4, wherein the first set of counters comprises a first preamble transmission counter associated with the first random access procedure and a first preamble power ramping counter associated with the first random access procedure, and the second set of counters comprises a second preamble transmission counter associated with the second random access procedure and a second preamble power ramping counter associated with the second random access procedure.

Aspect 6: The method of any of aspects 1 through 5, further comprising: receiving an indication of a first threshold value associated with a first preamble transmission counter in the first set of counters and a second threshold value associated with a second preamble transmission counter in the second set of counters, wherein the first set of counters and the second set of counters are updated based at least in part on the first threshold value and the second threshold value.

Aspect 7: The method of any of aspects 1 through 6, further comprising: resetting the values of the first set of counters based at least in part on the first random access procedure being successful; and incrementing the values of the second set of counters based at least in part on the second random access procedure being unsuccessful.

Aspect 8: The method of any of aspects 1 through 7, further comprising: receiving a first downlink control message of the first random access procedure in response to the first uplink random access channel message; receiving a first downlink control message of the second random access procedure in response to the second uplink random access channel message; initiating a first response window in response to receiving the first downlink control message of the first random access procedure; and initiating a second response window in response to receiving the first downlink control message of the second random access procedure, wherein the first response window and the second response window are independent of each other.

Aspect 9: The method of aspect 8, further comprising: receiving a second downlink message of the first random access procedure within the first response window; and incrementing the value of a preamble transmission counter in the second set of counters based at least in part on an expiration of the second response window prior to reception of a second downlink message of the second random access procedure.

Aspect 10: The method of aspect 9, wherein incrementing the value of a preamble power ramping counter in the second set of counters is based at least in part on signaling from a physical layer at the UE to a medium access control layer at the UE.

Aspect 11: The method of any of aspects 1 through 10, further comprising: receiving a third downlink control channel order triggering a second attempt of the second random access procedure based at least in part on a first attempt of the second random access procedure being unsuccessful; and transmitting a third uplink random access channel message in accordance with the third downlink control channel order triggering the second random access procedure.

Aspect 12: The method of aspect 11, further comprising: determining, at a physical layer at the UE, that a beam associated with the third uplink random access channel message is the same as a beam associated with the second uplink random access channel message; and notifying, a medium access control layer at the UE, to increment the value of a preamble power ramping counter in the second set of counters based at least in part on the determination; and incrementing, at the medium access control layer at the UE, the value of the preamble power ramping counter in the second set of counters based at least in part on the notifying.

Aspect 13: The method of any of aspects 11 through 12, further comprising: determining, at a physical layer at the UE, that a beam associated with the third uplink random access channel message is different from a beam associated with the second uplink random access channel message; and notifying, a medium access control layer at the UE, to suspend the value of a preamble power ramping counter in the second set of counters based at least in part on the determination; and suspending, at the medium access control layer at the UE, the value of the preamble power ramping counter in the second set of counters based at least in part on the notifying.

Aspect 14: The method of any of aspects 1 through 13, wherein the first downlink control channel order is associated with a first transmission reception point and the second downlink control channel order is associated with a second transmission reception point.

Aspect 15: The method of any of aspects 1 through 14, wherein the first downlink control channel order is associated with a first component carrier associated with at least a first timing advance group and the second downlink control channel order is associated with a second component carrier associated with at least a second timing advance group different from the first timing advance group.

Aspect 16: An apparatus for wireless communication at a UE, comprising a processor; memory coupled with the processor; and instructions stored in the memory and executable by the processor to cause the apparatus to perform a method of any of aspects 1 through 15.

Aspect 17: An apparatus for wireless communication at a UE, comprising at least one means for performing a method of any of aspects 1 through 15.

Aspect 18: A non-transitory computer-readable medium storing code for wireless communication at a UE, the code comprising instructions executable by a processor to perform a method of any of aspects 1 through 15.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
receiving a first downlink control channel order triggering a first random access procedure and a second downlink control channel order triggering a second random access procedure that temporally overlaps with the first random access procedure;
initiating a first set of counters associated with uplink power control for the first random access procedure and a second set of counters associated with uplink power control for the second random access procedure;
transmitting a first uplink random access channel message in accordance with the first downlink control channel order and a second uplink random access channel message in accordance with the second downlink control channel order; and
updating values of the first set of counters based at least in part on a first status of the first random access procedure and values of the second set of counters based at least in part on a second status of the second random access procedure.

2. The method of claim 1, wherein receiving the first downlink control channel order and the second downlink control channel order comprises:
receiving the first downlink control channel order associated with a first control resource set pool index value; and
receiving the second downlink control channel order associated with a second control resource set pool index value different from the first control resource set pool index value.

3. The method of claim 1, wherein receiving the first downlink control channel order and the second downlink control channel order comprises:
receiving the first downlink control channel order associated with a first timing advance group; and
receiving the second downlink control channel order associated with a second timing advance group different from the first timing advance group.

4. The method of claim 1, further comprising:
sending, from a physical layer at the UE to a medium access control layer at the UE, an indication of the first random access procedure and the second random access procedure;
setting, at the medium access control layer at the UE, a first random access target reception power for the first random access procedure based at least in part on the first set of counters and a second random access target reception power for the second random access procedure based at least in part on the second set of counters; and
instructing, the physical layer at the UE, to transmit a first random access preamble based at least in part on the first random access target reception power and a second random access preamble based at least in part on the second random access target reception power.

5. The method of claim 1, wherein the first set of counters comprises a first preamble transmission counter associated with the first random access procedure and a first preamble power ramping counter associated with the first random access procedure, and the second set of counters comprises a second preamble transmission counter associated with the second random access procedure and a second preamble power ramping counter associated with the second random access procedure.

6. The method of claim 1, further comprising:
receiving an indication of a first threshold value associated with a first preamble transmission counter in the first set of counters and a second threshold value associated with a second preamble transmission counter in the second set of counters, wherein the first set of counters and the second set of counters are updated based at least in part on the first threshold value and the second threshold value.

7. The method of claim 1, further comprising:
resetting the values of the first set of counters based at least in part on the first random access procedure being successful; and
incrementing the values of the second set of counters based at least in part on the second random access procedure being unsuccessful.

8. The method of claim 1, further comprising:
receiving a first downlink control message of the first random access procedure in response to the first uplink random access channel message;
receiving a first downlink control message of the second random access procedure in response to the second uplink random access channel message;
initiating a first response window in response to receiving the first downlink control message of the first random access procedure; and
initiating a second response window in response to receiving the first downlink control message of the second random access procedure, wherein the first response window and the second response window are independent of each other.

9. The method of claim 8, further comprising:
receiving a second downlink message of the first random access procedure within the first response window; and
incrementing the value of a preamble transmission counter in the second set of counters based at least in part on an expiration of the second response window prior to reception of a second downlink message of the second random access procedure.

10. The method of claim 9, wherein incrementing the value of a preamble power ramping counter in the second set of counters is based at least in part on signaling from a physical layer at the UE to a medium access control layer at the UE.

11. The method of claim 1, further comprising:
receiving a third downlink control channel order triggering a second attempt of the second random access procedure based at least in part on a first attempt of the second random access procedure being unsuccessful; and
transmitting a third uplink random access channel message in accordance with the third downlink control channel order triggering the second random access procedure.

12. The method of claim 11, further comprising:
determining, at a physical layer at the UE, that a beam associated with the third uplink random access channel message is same as a beam associated with the second uplink random access channel message;
notifying, a medium access control layer at the UE, to increment the value of a preamble power ramping counter in the second set of counters based at least in part on the determination; and
incrementing, at the medium access control layer at the UE, the value of the preamble power ramping counter in the second set of counters based at least in part on the notifying.

13. The method of claim 11, further comprising:
determining, at a physical layer at the UE, that a beam associated with the third uplink random access channel message is different from a beam associated with the second uplink random access channel message;
notifying, a medium access control layer at the UE, to suspend the value of a preamble power ramping counter in the second set of counters based at least in part on the determination; and
suspending, at the medium access control layer at the UE, the value of the preamble power ramping counter in the second set of counters based at least in part on the notifying.

14. The method of claim 1, wherein the first downlink control channel order is associated with a first transmission reception point and the second downlink control channel order is associated with a second transmission reception point.

15. The method of claim 1, wherein the first downlink control channel order is associated with a first component carrier associated with at least a first timing advance group and the second downlink control channel order is associated with a second component carrier associated with at least a second timing advance group different from the first timing advance group.

16. An apparatus for wireless communication at a user equipment (UE), comprising:
a processor;
memory coupled with the processor; and
instructions stored in the memory and executable by the processor to cause the apparatus to:
receive a first downlink control channel order triggering a first random access procedure and a second downlink control channel order triggering a second random access procedure that temporally overlaps with the first random access procedure;
initiate a first set of counters associated with uplink power control for the first random access procedure and a second set of counters associated with uplink power control for the second random access procedure;
transmit a first uplink random access channel message in accordance with the first downlink control channel order and a second uplink random access channel message in accordance with the second downlink control channel order; and
update values of the first set of counters based at least in part on a first status of the first random access procedure and values of the second set of counters based at least in part on a second status of the second random access procedure.

17. The apparatus of claim 16, wherein the instructions to receive the first downlink control channel order and the second downlink control channel order are executable by the processor to cause the apparatus to:
receive the first downlink control channel order associated with a first control resource set pool index value; and
receive the second downlink control channel order associated with a second control resource set pool index value different from the first control resource set pool index value.

18. The apparatus of claim 16, wherein the instructions to receive the first downlink control channel order and the second downlink control channel order are executable by the processor to cause the apparatus to:
receive the first downlink control channel order associated with a first timing advance group; and
receive the second downlink control channel order associated with a second timing advance group different from the first timing advance group.

19. The apparatus of claim 16, wherein the instructions are further executable by the processor to cause the apparatus to:
send, from a physical layer at the UE to a medium access control layer at the UE, an indication of the first random access procedure and the second random access procedure;
set, at the medium access control layer at the UE, a first random access target reception power for the first random access procedure based at least in part on the first set of counters and a second random access target reception power for the second random access procedure based at least in part on the second set of counters; and
instruct, the physical layer at the UE, to transmit a first random access preamble based at least in part on the first random access target reception power and a second random access preamble based at least in part on the second random access target reception power.

20. The apparatus of claim 16, wherein the first set of counters comprises a first preamble transmission counter associated with the first random access procedure and a first preamble power ramping counter associated with the first random access procedure, and the second set of counters comprises a second preamble transmission counter associated with the second random access procedure and a second preamble power ramping counter associated with the second random access procedure.

21. The apparatus of claim 16, wherein the instructions are further executable by the processor to cause the apparatus to:
receive an indication of a first threshold value associated with a first preamble transmission counter in the first set of counters and a second threshold value associated with a second preamble transmission counter in the second set of counters, wherein the first set of counters and the second set of counters are updated based at least in part on the first threshold value and the second threshold value.

22. The apparatus of claim 16, wherein the instructions are further executable by the processor to cause the apparatus to:
reset the values of the first set of counters based at least in part on the first random access procedure being successful; and
increment the values of the second set of counters based at least in part on the second random access procedure being unsuccessful.

23. The apparatus of claim 16, wherein the instructions are further executable by the processor to cause the apparatus to:
receive a first downlink control message of the first random access procedure in response to the first uplink random access channel message;
receive a first downlink control message of the second random access procedure in response to the second uplink random access channel message;
initiate a first response window in response to receiving the first downlink control message of the first random access procedure; and
initiate a second response window in response to receiving the first downlink control message of the second random access procedure, wherein the first response window and the second response window are independent of each other.

24. The apparatus of claim 23, wherein the instructions are further executable by the processor to cause the apparatus to:
receive a second downlink message of the first random access procedure within the first response window; and
increment the value of a preamble transmission counter in the second set of counters based at least in part on an expiration of the second response window prior to reception of a second downlink message of the second random access procedure.

25. The apparatus of claim 24, wherein incrementing the value of a preamble power ramping counter in the second set of counters is based at least in part on signaling from a physical layer at the UE to a medium access control layer at the UE.

26. The apparatus of claim 16, wherein the instructions are further executable by the processor to cause the apparatus to:
receive a third downlink control channel order triggering a second attempt of the second random access procedure based at least in part on a first attempt of the second random access procedure being unsuccessful; and
transmit a third uplink random access channel message in accordance with the third downlink control channel order triggering the second random access procedure.

27. The apparatus of claim 26, wherein the instructions are further executable by the processor to cause the apparatus to:
determine, at a physical layer at the UE, that a beam associated with the third uplink random access channel message is same as a beam associated with the second uplink random access channel message;
notify, a medium access control layer at the UE, to increment the value of a preamble power ramping counter in the second set of counters based at least in part on the determination; and
increment, at the medium access control layer at the UE, the value of the preamble power ramping counter in the second set of counters based at least in part on the notifying.

28. The apparatus of claim 26, wherein the instructions are further executable by the processor to cause the apparatus to:
determine, at a physical layer at the UE, that a beam associated with the third uplink random access channel message is different from a beam associated with the second uplink random access channel message;
notify, a medium access control layer at the UE, to suspend the value of a preamble power ramping counter in the second set of counters based at least in part on the determination; and
suspend, at the medium access control layer at the UE, the value of the preamble power ramping counter in the second set of counters based at least in part on the notifying.

29. An apparatus for wireless communication at a user equipment (UE), comprising:
means for receiving a first downlink control channel order triggering a first random access procedure and a second downlink control channel order triggering a second random access procedure that temporally overlaps with the first random access procedure;
means for initiating a first set of counters associated with uplink power control for the first random access procedure and a second set of counters associated with uplink power control for the second random access procedure;
means for transmitting a first uplink random access channel message in accordance with the first downlink control channel order and a second uplink random access channel message in accordance with the second downlink control channel order; and
means for updating values of the first set of counters based at least in part on a first status of the first random access procedure and values of the second set of counters based at least in part on a second status of the second random access procedure.

30. A non-transitory computer-readable medium storing code for wireless communication at a user equipment (UE), the code comprising instructions executable by a processor to:
receive a first downlink control channel order triggering a first random access procedure and a second downlink control channel order triggering a second random access procedure that temporally overlaps with the first random access procedure;
initiate a first set of counters associated with uplink power control for the first random access procedure and a second set of counters associated with uplink power control for the second random access procedure;
transmit a first uplink random access channel message in accordance with the first downlink control channel order and a second uplink random access channel message in accordance with the second downlink control channel order; and
update values of the first set of counters based at least in part on a first status of the first random access procedure and values of the second set of counters based at least in part on a second status of the second random access procedure.
